(19) United States
(12) Patent Application Publication
(10) Pub. No.: US 2008/0064388 A1
(43) Pub. Date: Mar. 13, 2008

(54) Softkey access to network connections

(75) Inventors: Matias Duarte, Los Angeles, CA (US); Gregory Paul Hayes, Santa Monica, CA (US); Peter J. Ford, Los Angeles, CA (US)

Correspondence Address: Kirkpatrick & Lockhart Preston Gates Ellis LLP;(FORMERLY KIRKPATRICK & LOCKHART NICHOLSON GRAHAM), STATE STREET FINANCIAL CENTER, One Lincoln Street, BOSTON, MA, 02111-2950, US

(73) Assignee: Helio, LLC., Los Angeles, CA (US)

(21) Appl. No.: 11/520,335

(22) Filed: Sep. 13, 2006

(51) Int. Cl. H04Q 7/20

(52) U.S. Cl. 455/425

(57) ABSTRACT

Methods and systems are provided by which a mobile device may be configured to display a list of available networks in response to a single action. In particular, some embodiments of the present invention include a softkey that may be programmed to view a menu of available wireless networks.

### FIELD OF THE INVENTION

The present invention relates generally to wireless communications and, more particularly, to a system and method for managing network connections for a mobile device.

### BACKGROUND

For users of mobile devices, managing connections with local area networks can require burdensome and sometimes complex navigation of menus. Typically mobile users navigate a series of menus to access, for example, a connection manager, a connection tab, or a control panel to setup, or even reconnect, to a local area network. A simpler user interface is needed.

### SUMMARY OF THE INVENTION

Embodiments of the present invention provide systems and methods for simplifying user management network connections for a mobile device. In more specific terms, certain embodiments may be used to configure a mobile device to display a list of available networks in response to a single action by the user.

### BRIEF DESCRIPTION OF THE DRAWINGS

These embodiments and other aspects of this invention will be readily apparent from the detailed description below and the appended drawings, which are meant to illustrate and not to limit the invention, and in which:

FIG. 1 is a functional block diagram that illustrates the components of an exemplary system for practicing an embodiment of the present invention;

FIG. 2 is a schematic diagram that illustrates an exemplary environment for practicing an embodiment of the present invention;

FIG. 3 is a schematic diagram that illustrates an exemplary environment for practicing an embodiment of the present invention;

FIG. 4 is a schematic diagram of an exemplary display screen according to an embodiment of the present invention; and

FIG. 5 is a process diagram that illustrates an exemplary method for practicing an embodiment of the present invention.

### DETAILED DESCRIPTION OF THE PREFERRED EMBODIMENTS

The present invention will be more completely understood through the following detailed description, which should be read in conjunction with the attached drawings. In this description, like numbers refer to similar elements within various embodiments of the present invention. Within this detailed description, the claimed invention will be explained with respect to preferred embodiments. However, the skilled artisan will readily appreciate that the methods and systems described herein are merely exemplary and that variations can be made without departing from the spirit and scope of the invention.

Embodiments of the present invention relate to systems and methods for managing network connections for a mobile device. Some embodiments include a softkey (i.e., a software key) that may be programmed to view and select from a menu of available wireless networks. For example, the mobile device may be configured to display a list of available networks in response to a single action by the user, such as by a single press of the softkey.

In the following discussion of illustrative embodiments, the term “softkey” includes, without limitation, a hard key without a fixed function, or alternatively, a virtual or screen button that appears on a touch screen. In either configuration, softkeys may be programmed to perform dynamic functions. The term “user” refers to an individual using a mobile device.

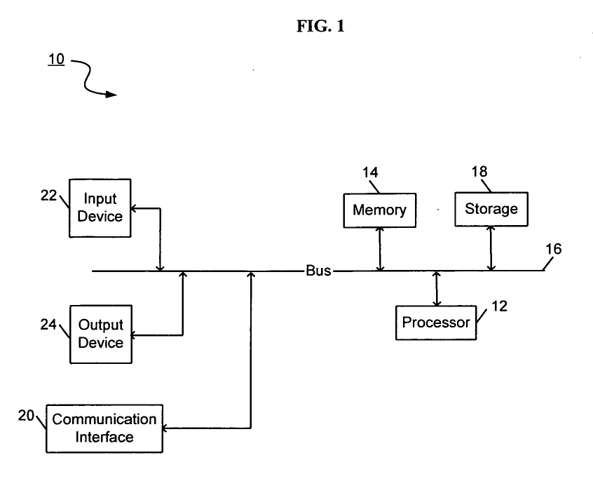

FIG. 1 is a functional block diagram that illustrates the components of an exemplary mobile device 10 for practicing an embodiment of the present invention. Mobile device 10 preferably includes a processing unit 12, a system memory 14, a disk storage 18, a communication interface 20, an input device 22, an output device 24, and a system bus 16. System bus 16 couples system components including, but not limited to, system memory 14 to processing unit 12. The processing unit 12 can be any of various available processors.

Input device 22 may be a keyboard, thumbboard, or touchscreen (for use with a stylus) that are used to receive data from a user. Output device 24 may be a display device, such as an LCD or LED display screen. Those skilled in the art will appreciate that a graphical user interface may be implemented with touchscreen technology in which the functions of output device 24 and input device 22 may be combined.

Communication interface 20 facilitates data exchange over a variety of wireless. The hardware and software necessary for connection to the communication interface 20 includes, for exemplary purposes only, internal and external components that transmit and receive data wirelessly across a plurality of standard protocols including, for example, PCS, GSM, CDMA, Bluetooth, WiFi, IrDA, WiMAX, WiBRO or through other known wireless standards.

Storage 18 may include removable or fixed, volatile or non-volatile or permanent or re-writable computer storage media. The computer readable medium can be any available medium that can be accessed by a general purpose or special purpose mobile device. By way of example, and not limitation, such a computer readable medium can comprise flash memory, RAM, ROM, electrically erasable programmable read only memory (EEPROM), optical disk storage, magnetic disk storage or other magnetic storage devices, or any other medium that can be used to store digital information on a mobile device.

It is to be appreciated that FIG. 1 describes software that acts as an intermediary between users and the basic resources described in mobile device 10. Such software preferably includes an operating system. The operating system, which can be resident in storage 18, acts to control and allocate resources of mobile device 10. System applications take advantage of the management of resources by the operating system through program modules and program data stored either in system memory 14 or on disk storage 18. Furthermore, it is to be appreciated that the present invention can be implemented with various operating systems or combinations of operating systems.

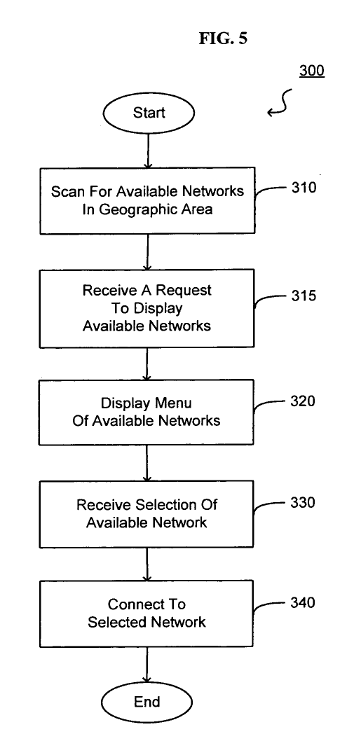

The computer readable medium tangibly embodies a program, functions, and/or instructions that cause the computer system to operate in a specific and predefined manner as described herein. Those skilled in the art will appreciate, however, that the process described below, such as the process illustrated in FIG. 5, may be implemented at any level, ranging from hardware to application software and in any appropriate physical location. For example, the present invention may be implemented as software code to be executed by mobile device 10 using any suitable computer language and may be stored on any of the storage media described above, or can be configured into the logic of mobile device 10. Such software code may be executed by mobile device 10 using any suitable computer language such as, for example, Java, Javascript, C++, C, C#, Perl, Visual Basic, Transact/Structure Query Language (T/SQL), database languages, APIs, various system-level SDKs, assembly, firmware, microcode, and/or other languages and tools.

These are representative components of a mobile device whose operation is well understood. Furthermore, those of ordinary skill in the art will appreciate that mobile device 10 of FIG. 1 is exemplary only and that the present invention can operate within a number of different mobile devices including network-enabled wireless mobile phones, personal digital assistants (PDA) and so forth.

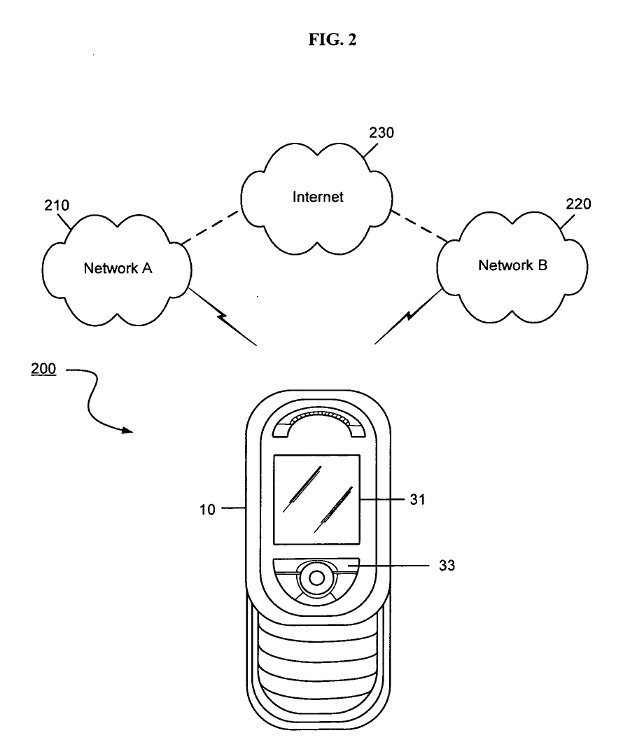

FIG. 2 is a schematic diagram that illustrates an exemplary environment 200 for practicing an embodiment of the present invention. Environment 200 includes mobile device 10 functionally proximate to networks 210 and 220 that, in turn, are optionally connected to the Internet 230 or to each other. In the illustrated embodiment, mobile device 10 includes softkey labels drawn on the display screen 31 adjacent to the softkey, so that the function and action associated with the softkey may be readily defined and re-defined according to the particular state of the user interface. When pressed or otherwise activated, softkey 33 causes mobile device 10 to display a list of available networks, such as network A 210 and network B 220. As an example, network A 210 may comprise a GSM cellular network, while network B 220 may comprise a WiFi data network.

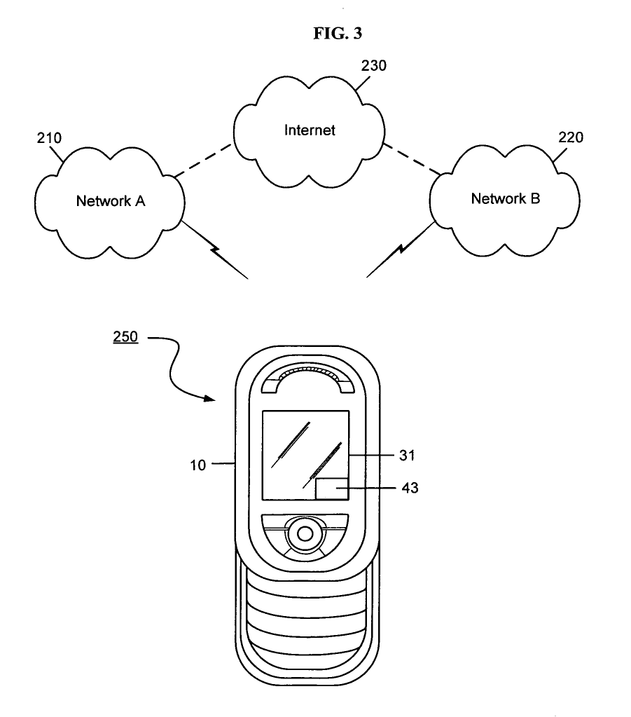

FIG. 3 is a schematic diagram that illustrates an exemplary environment 250 for practicing an embodiment of the present invention. Environment 250 includes a mobile device 40 functionally proximate to network A 210 and network B 220 that, in turn, are optionally connected to the Internet 230 or to each other. Mobile device 40 is similar in many respects to mobile device 10 shown in FIG. 2, except that display screen 31 is a touchscreen and softkey 43 is programmed to be displayed thereon.

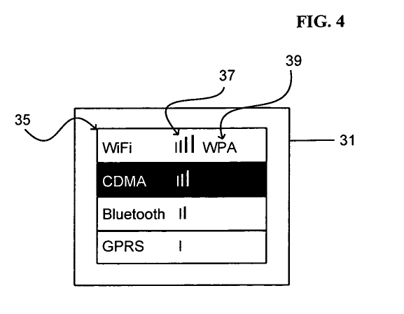

FIG. 4 is a schematic diagram of an exemplary display screen 31 according to an embodiment of the present invention. In the illustrated embodiment, display screen 31 shows a menu 35 that includes a series of menu items, where each menu item corresponds to an available network. In the illustrated embodiment, “active” items are displayed in inverse video on display screen 31. Menu 35 may include certain attributes of the available networks, such as a signal strength indicator 37 and/or an encryption, security, network provider (or other relevant detail) indicator 39. In some embodiments, the mobile device may be configured to sort the available networks by signal strength indicator 37, such as from strongest to weakest.

FIG. 5 is a process diagram that illustrates an exemplary method 300 for operating mobile device 10 illustrated in FIG. 2. In step 310, mobile device 10 scans for available networks in the local geographic area. In step 315, a user input in the form of a single action, such as a press by the user of softkey 33, is received by the processor 12 which handles the details of interpreting the location of the action, or key press. Those skilled in the art will appreciate that step 310 and step 315 can occur in either order. In step 320, mobile device 10 displays a menu of available networks, such as menu 35, and waits for selection of a network by the user. In various embodiments, a short press of the softkey 33 may cause mobile device 10 to display a brief listing of available wireless networks, while a longer duration press may display a more detailed menu.

In step 330, a user input may alter the active menu item in a conventional manner, such as by use of the up and down arrow keys. The active menu item, which corresponds to a certain network, may then be selected by use of left or right arrow keys, a confirm key, or softkey 33. Once selected, and mobile device 10 instructs processor 12 to communicate through network 210 in step 340.

Operation of mobile device 40 is similar in many respects to the operation of mobile device 10 except that, in step 320, the user presses softkey 43 instead of softkey 33. Additionally, in step 330, menu 35 may include a series of softkey options, where each softkey option corresponds to an available wireless network. Touchscreen input or depressing of a certain menu item leads immediately to the selection of that network and will cause mobile device 40 to proceed to the next step. Optionally, softkey 43 may be configured in either an absolute or relative mode. For example, in relative mode, softkey 43 may appear in the lower right hand corner of display screen 31 regardless of whether the user of mobile device 40 views display screen 31 in a landscape or portrait orientation.

Variations, modifications, and other implementations of what is described herein will occur to those of ordinary skill in the art without departing from the spirit and scope of the invention as claimed. Accordingly, the invention is to be defined not by the preceding illustrative description but instead by the spirit and scope of the following claims.

1. A mobile device comprising:
a display;
a processor; and
a memory for storing computer readable instructions that, when executed by the processor, cause the mobile device to display at least one softkey, wherein the softkey is adapted to generate a menu of available wireless networks with a single action.

2. The mobile device of claim 1 wherein the softkey is part of the display.

3. The mobile device of claim 1 wherein the softkey is a hardkey.

4. The mobile device of claim 1 wherein the softkey is positioned adjacent to the display.

5. The mobile device of claim 1 wherein the menu of available networks includes an indicator of network signal strength for each network.

6. The mobile device of claim 1 wherein the menu of available networks includes an indicator of network encryption.

7. The mobile device of claim 1 wherein the function of the designated softkey is determined according to the device's orientation.

8. A method for operating a mobile device, comprising:
in response to only a single action being performed, displaying information identifying a network;
receiving a request relating to the network; and
connecting the mobile device to the network.

9. The method of claim 8 wherein the single action comprises pressing a button.

10. The method of claim 9 wherein the button comprises a softkey.

11. The method of claim 8 wherein the single action comprises a verbal command.

12. The method of claim 8 further comprising:
scanning to identify the network.

13. The method of claim 8 wherein the network is available for the mobile device to connect.

14. The method of claim 8 wherein the single action includes pressing and holding a softkey.

15. The method of claim 14 wherein the mobile device displays more information about the network for a long duration press than for a short duration press.
